(19) United States
(12) Patent Application Publication
(10) Pub. No.: US 2010/0096081 A1
(43) Pub. Date: Apr. 22, 2010

(54) METHOD OF MANUFACTURING INK-JET HEAD

(75) Inventors: Pil-Joong KANG, Jinji-si (KR); Jae-Woo JOUNG, Suwon-si (KR); Young-Seuck YOO, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/437,082

(22) Filed: May 7, 2009

(30) Foreign Application Priority Data
Oct. 20, 2008 (KR) 10-2008-0102532

(51) Int. Cl. B32B 37/06

(52) U.S. Cl. 156/272.8

(57) ABSTRACT

Disclosed is a method of manufacturing an ink-jet head including a reservoir storing ink, an inlet port through which the ink is provided to the reservoir, a chamber provided with the ink from the reservoir, a restrictor linking the reservoir and the chamber, and a nozzle through which the ink in the chamber is discharged. The method in accordance with an embodiment of the present invention includes: processing a first plate in which the inlet port is formed; processing a second plate in which the chamber and the inlet port are formed; bonding the first plate on an upper surface of the second plate; processing a third plate in which the restrictor and the reservoir are formed; processing a fourth plate by irradiating a femtosecond laser such that the nozzle is formed; bonding the fourth plate on a lower surface of the third plate, and bonding the third plate on a lower surface of the second plate.

### CROSS-REFERENCE TO RELATED APPLICATIONS

This application claims the benefit of Korean Patent Application No. 10-2008-0102532, filed with the Korean Intellectual Property Office on Oct. 20, 2008, the disclosure of which is incorporated herein by reference in its entirety.

### BACKGROUND

1. Technical Field

The present invention relates to a method of manufacturing an ink-jet head.

2. Description of the Related Art

An ink-jet head uses a principle of discharging ink in the form of a droplet through a small nozzle by converting an electrical signal to a physical force. FIG. 1 is a cross-sectional view showing a method of manufacturing an ink-jet head according to a conventional technology. As shown in FIG. 1, the ink-jet head 1 is manufactured by bonding a first plate 2 in which an inlet port 2a is formed, a second plate 3 in which a chamber 3a and a restrictor 3b are formed, a third plate 4 in which a filter 4a and a reservoir 4b are formed and a fourth plate 5 in which a nozzle is formed.

Here, a wafer made of a silicon material is used as the first through fourth plates 2, 3, 4 and 5. The first through fourth plates 2, 3, 4 and 5 are bonded by directly bonding silicon wafers. However, since the yield of direct silicon bonding is below 50%, the direct silicon bonding is not feasible for a mass-production technology.

Additionally, when bonding the first through fourth plates 2, 3, 4 and 5 by using the direct silicon bonding, it is required that the fourth plate 5 in which the nozzle 5a be thicker than a certain value. The nozzle 5a is processed through Silicon Deep Reactive Ion Etching.

If the nozzle is processed by the Silicon Deep Reactive Ion Etching, as shown in FIG. 1, a step difference may be formed around the bottom of the nozzle 5a, and an etching surface may not be uniform because there is no separate etching stop. Such nozzle 5a causes bubble to be generated while discharging the ink and may lower the discharge performance of the ink-jet head 1.

### SUMMARY

The present invention provides a method of manufacturing an ink-jet head that is capable of improving discharge characteristics of a nozzle.

An aspect of the present invention features a method for manufacturing an ink-jet head including a reservoir storing ink, an inlet port through which the ink is provided to the reservoir, a chamber provided with the ink from the reservoir, a restrictor linking the reservoir and the chamber, and a nozzle through which the ink in the chamber is discharged. The method in accordance with an embodiment of the present invention includes: processing a first plate in which the inlet port is formed; processing a second plate in which the chamber and the inlet port are formed; bonding the first plate on an upper surface of the second plate; processing a third plate in which the restrictor and the reservoir are formed; processing a fourth plate by irradiating a femtosecond laser such that the nozzle is formed; bonding the fourth plate on a lower surface of the third plate; and bonding the third plate on a lower surface of the second plate.

Here, the fourth plate can be made of a glass material. The third plate can be made of a silicon material. The bonding of the third plate with the fourth plate can be performed by anodic-bonding the fourth plate with the lower surface of the third plate

The first plate can be made of a silicon material. The second plate can be made of a glass material. The bonding of the first plate with the second plate can be performed by anodic-bonding the first plate with the upper surface of the second plate.

In addition, the second plate can be made of a glass material. The third plate can be made of a silicon material. The bonding of the second plate with the third plate can be performed by anodic-bonding the third plate with the upper surface of the second plate.

### BRIEF DESCRIPTION OF THE DRAWINGS

FIG. 1 is a cross-sectional view showing a method of manufacturing an ink-jet head according to a conventional technology.

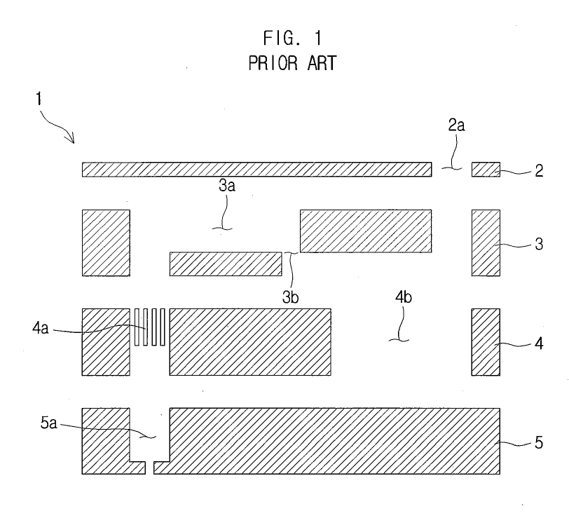

FIG. 2 is a cross-sectional view showing an ink-jet head according to an embodiment of the present invention.

FIG. 3 is a flowchart showing a method of manufacturing an ink-jet head according to an embodiment of the present invention.

FIG. 4 is a cross-sectional view showing a first plate of an ink-jet head according to an embodiment of the present invention.

FIG. 5 is a cross-sectional view showing a second plate of an ink-jet head according to an embodiment of the present invention.

FIG. 6 is a cross-sectional view showing anodic-bonding of a first plate and a second plate of an ink-jet head according to an embodiment of the present invention.

FIG. 7 is a cross-sectional view showing a third plate of an ink-jet head according to an embodiment of the present invention.

FIG. 8 is a cross-sectional view showing a nozzle processing of an ink-jet head according to an embodiment of the present invention.

FIG. 9 is an image showing a nozzle of an ink-jet head according to an embodiment of the present invention.

FIG. 10 is a cross-sectional view showing anodic-bonding of a third plate and a fourth plate according to an embodiment of the present invention.

FIG. 11 is a cross-sectional view showing anodic-bonding of a second plate and a third plate according to an embodiment of the present invention.

### DETAILED DESCRIPTION

Characteristics and advantages of the present invention will be clear with the following drawings and detailed description of the present invention.

Hereinafter, a certain embodiment of a method of manufacturing an ink-jet head will be described in detail with reference to the accompanying drawings. In description with reference to accompanying drawings, the same reference numerals will be assigned to the same or corresponding elements, and any redundant description will be omitted.

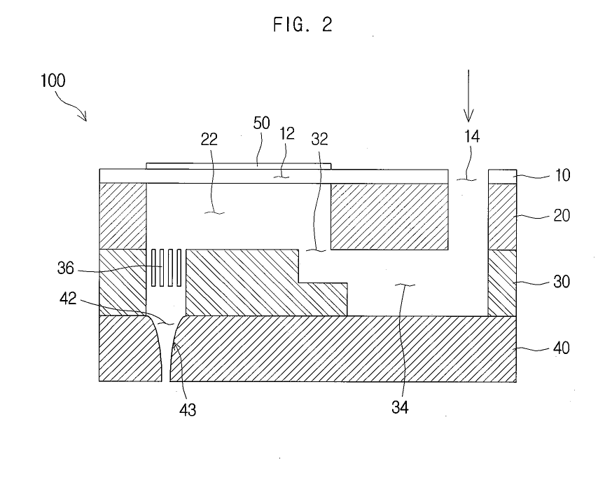

FIG. 2 is a cross-sectional view showing an ink-jet head 100 according to an embodiment of the present invention. As shown in FIG. 2, the ink-jet head 100 according to an embodiment of the present invention can include a reservoir 34, an inlet port 14, a chamber 22, a membrane 12, a restrictor 32, a piezoelectric member 50, a filter 36 and a nozzle 42.

The chamber 22 accommodates ink. The membrane 12 transferring vibration of the piezoelectric member 50 is formed on one side of the chamber 22. If the piezoelectric member 50 is vibrated, the ink in the chamber 22 is transferred toward the nozzle 42 and discharged to the outside of the ink-jet head 100.

The reservoir 34 is provided with the ink from the outside of the ink-jet head 100 through the inlet port 14 and stores the ink. The ink stored in the reservoir 34 is supplied to the chamber 22.

The restrictor 32 links the reservoir 34 with the chamber 22 and performs a function of controlling the flow of ink between the reservoir 34 and the chamber 22. Such restrictor 32 is formed to have a smaller cross sectional area than those of the reservoir 34 and the chamber 22. When the membrane 12 is vibrated by the piezoelectric member 50, it is possible to control the amount of ink provided from the reservoir 34 to the chamber 22.

The nozzle 42 is linked with the chamber 22 and performs a function of spraying the ink provided from the chamber 22. When the vibration generated by the piezoelectric member 50 is transferred to the chamber 22 through the membrane 12, pressure is applied to the chamber 22, and then the ink can be discharged through the nozzle 42 by the pressure.

Meanwhile, a filter 36 is formed between the chamber 22 and the nozzle 42. The filter 36 can converge the energy generated by the chamber 22 to the nozzle 42 and buffer a sudden change of pressure.

The ink-jet head 100 can be completed by conjoining the first through fourth plates 10, 20, 30 and 40, each of which is formed with the structure described above. Hereinafter, a method of manufacturing the ink-jet head 100 according to an embodiment of the present invention will be described.

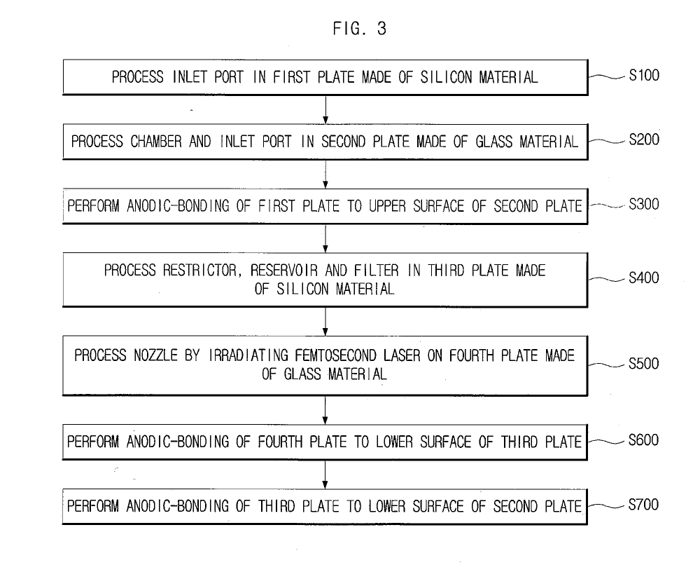

FIG. 3 is a flowchart showing a method of manufacturing an ink-jet head 100 according to an embodiment of the present invention. As shown in FIG. 3, the method of manufacturing an ink-jet head 100 according to an embodiment of the present invention includes processing the first plate 10 in which the inlet port 14 is formed, processing the second plate 20 in which the chamber 22 and the inlet port 14 are formed, bonding the first plate 10 on the upper surface of the second plate 20, processing the third plate 30 in which the restrictor 32 and the reservoir 34 are formed, processing the fourth plate 40 by irradiating a femtosecond laser such that the nozzle 42 is formed, bonding the fourth plate 40 on the lower surface of the third plate 30, and bonding the third plate 30 on the lower surface of the second plate 20. Accordingly, a flow-passage resistance is reduced, thereby an ink-jet head 100 having the nozzle 42 of improved discharge performance can be manufactured.

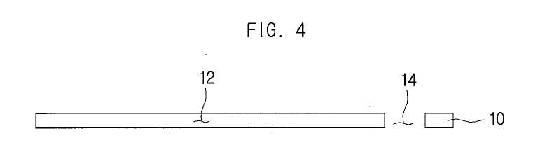

FIG. 4 is a cross-sectional view showing a first plate 10 of the ink-jet head 100 according to an embodiment of the present invention. First, as shown in FIG. 4, the inlet port 14 is processed in the first plate 10 made of a silicon material (S100). Part of the first plate 10 corresponding to the location of the chamber 22 is later bonded with the piezoelectric member 50 to function as the membrane 12. The inlet port 14 is formed by etching a part of the first plate 10.

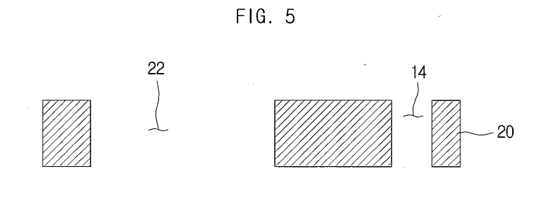

FIG. 5 is a cross-sectional view showing a second plate 20 of the ink-jet head 100 according to an embodiment of the present invention. As shown in FIG. 5, the chamber 22 and the inlet port 14 are processed in the second plate 20 made of a glass material (S200). The chamber 22 and the inlet port 14 can be formed by selectively removing parts of the second plate 20. Since the shapes of the chamber 22 and the inlet port 14 are not complex, a low-priced precision processing technology, such as a wet glass etching method or a sand blast method, can be used, thereby reducing the manufacturing cost.

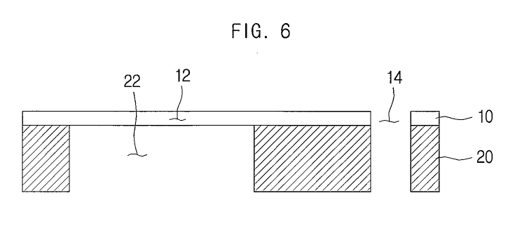

FIG. 6 is a cross-sectional view showing anodic-bonding of a first plate 10 and a second plate 20 of the ink-jet head 100 according to an embodiment of the present invention. As shown in FIG. 6, the first plate 10 is anodic-bonded on the upper surface of the second plate 20 (S300).

As described above, because the first plate 10 is made of a silicon material and the second plate 20 is made of a glass material, the first plate 10 and the second plate 20 can be anodic-bonded with each other. Therefore, the first plate 10 can be strongly bonded with the second plate 20, improving the reliability of the ink-jet head 100, which is a final product.

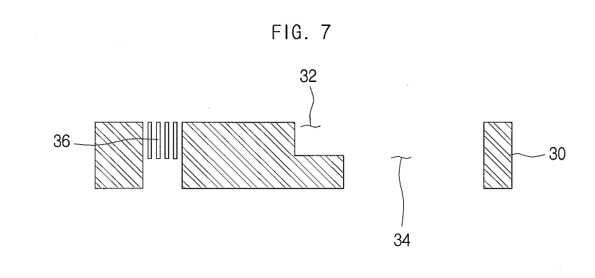

FIG. 7 is a cross-sectional view showing a third plate 30 of the ink-jet head 100 according to an embodiment of the present invention. As shown in FIG. 7, the restrictor 32, the reservoir 34 and the filter 36 are processed in the third plate 30 made of a silicon material (S400).

The restrictor 32, the reservoir 34 and the filter 36 can be formed by etching the third plate 30. Particularly, a precision processing is required for the restrictor 32, which can greatly affect the discharge characteristics of the ink-jet head 100. Since the third plate 30 is made of a silicon material, the restrictor 32 with an improved processing precision can be formed through Silicon Deep Reactive Ion Etching.

In the mean time, while the embodiment of the present invention has been described with reference to an example of a case where the restrictor 32 is formed in the third plate 30, it shall be evident that the restrictor 32 can be also formed in the second plate 20 depending on the structure of the ink-jet head 100.

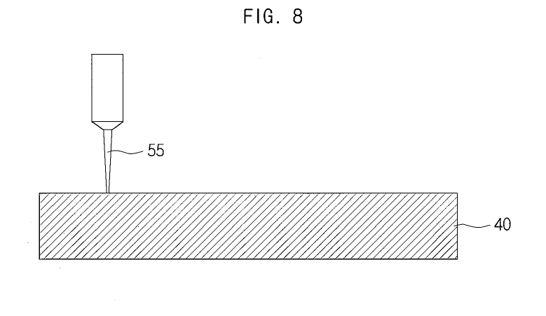

FIG. 8 is a cross-sectional view showing processing a nozzle 42 of the ink-jet head 100 according to an embodiment of the present invention. As shown in FIG. 8, the nozzle 42 is processed by irradiating the femtosecond laser 55 on the fourth plate 40 made of a glass material (S500). The spot size of the femtosecond laser 55 to be irradiated can be controlled such that the diameter of the upper part of the nozzle 42 is the same as the diameter of the flow passage in which the filter 36 is formed.

The femtosecond laser 55 is a kind of a pulse laser and has its pulse width of femtoseconds. Even though the total amount of energy of the femtosecond laser 55 is not high, the femtosecond laser 55 has a high intensity because the energy is compressed to femtoseconds.

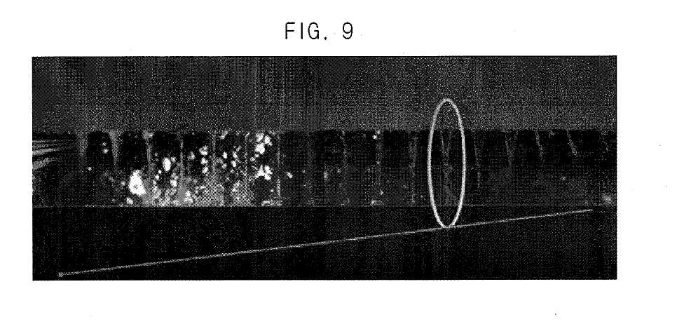

FIG. 9 is an image showing a nozzle 42 of the ink-jet head 100 according to an embodiment of the present invention. As shown in FIG. 9, if the femtosecond laser having a Gaussian distribution is irradiated to penetrate through the fourth plate 40, the cone-shaped nozzle 42 is formed in the fourth plate 40. In this case, an inner circumferential surface 43 of the nozzle 42 is formed convexly toward the inside, reducing the flow-passage resistance of the ink to the minimum. Accordingly, when the ink-jet head 100 discharges the ink through the nozzle 42, it is possible to prevent bubbles from being generated. Thus, the discharge performance of the ink-jet head 100 can be improved.

In addition, unlike a common processing laser such as a CO2 laser or a YAG laser, the femtosecond laser can perform an ablation processing that causes no heat diffusion around the nozzle 42. Therefore, because debris is not generated around the formed nozzle 42, an additional process for removing the debris can be omitted in a later bonding process. Besides, the femtosecond laser has a high-speed of processing, and thus a mass productivity can be sufficiently obtained.

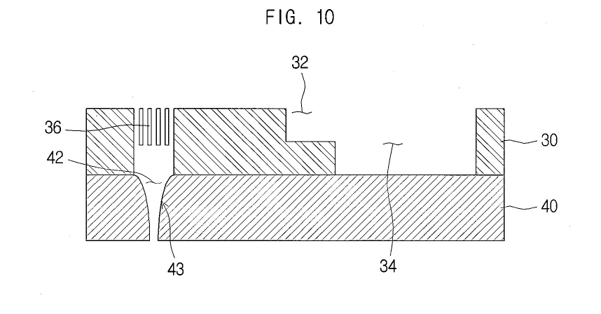

FIG. 10 is a cross-sectional view showing anodic-bonding of the third plate 30 and the fourth plate 40 according to an embodiment of the present invention. As shown in FIG. 10, the fourth plate 40 is anodic-bonded on the lower surface of the third plate 30 (S600). Because the third plate 30 is made of a silicon material and the fourth plate 40 is made of a glass material, the third plate 30 and the fourth plate 40 can be anodic-bonded with each other.

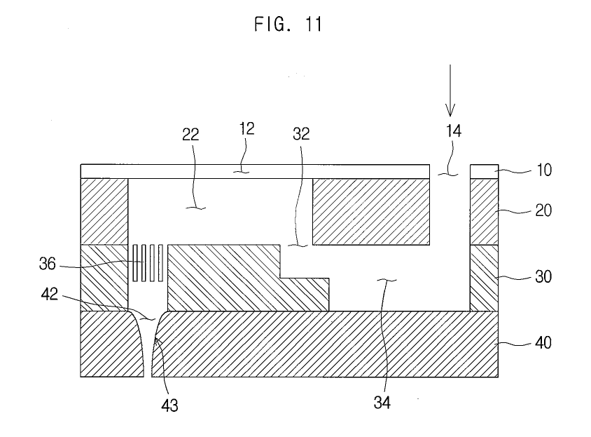

FIG. 11 is a cross-sectional view showing anodic-bonding of the second plate 20 and the third plate 30 according to an embodiment of the present invention. As shown in FIG. 11, the third plate 30, on which the fourth plate 40 is bonded, is anodic-bonded with the lower surface of the second plate 20, on which the first plate 10 is bonded (S700). As described above, because the second plate 20 is made of a glass material and the third plate 30 is made of a silicon material, the second plate 20 and the third plate 30 fourth plate 40 can be also anodic-bonded with each other.

After that, the piezoelectric member 50 is bonded on a part of the first plate 10 corresponding to the location of the chamber 22, and then an actuator can be formed on the ink-jet head 100 as shown in FIG. 2.

As a result, the ink-jet head 100 according to an embodiment of the present invention can be formed through the anodic-bonding method by alternately placing the silicon material and the glass material. Therefore, the reliability of the bonding is improved, thereby increasing the manufacturing yield.

Furthermore, through the method for manufacturing the ink-jet head 100 including the cone-shaped nozzle 42 that is formed to have the inner circumferential surface 43 being formed convexly toward the inside by use of the femtosecond laser, the flow-passage resistance of the ink discharged through the nozzle 42 is reduced, and bubbles are prevented from being generated, thereby improving the discharge characteristics of the ink-jet head 100.

While the present invention has been described with reference to a particular embodiment thereof, it shall be understood by those skilled in the art that various changes and modification in forms and details can be made without departing from the spirit and scope of the present invention as defined by the appended claims.

What is claimed is:

1. A method of manufacturing an ink-jet head comprising a reservoir storing ink, an inlet port through which the ink is provided to the reservoir, a chamber provided with the ink from the reservoir, a restrictor linking the reservoir and the chamber, and a nozzle through which the ink in the chamber is discharged, the method comprising:
processing a first plate in which a portion of the inlet port is formed;
processing a second plate in which the chamber and another portion of the inlet port are formed;
bonding the first plate on an upper surface of the second plate;
processing a third plate in which the restrictor and the reservoir are formed;
processing a fourth plate by irradiating a femtosecond laser such that the nozzle is formed;
bonding the fourth plate on a lower surface of the third plate; and
bonding the third plate on a lower surface of the second plate.

2. The method of claim 1, wherein the fourth plate is made of a glass material.

3. The method of claim 2, wherein:
the third plate is made of a silicon material; and
the bonding of the third plate with the fourth plate is performed by anodic-bonding the fourth plate with the lower surface of the third plate.

4. The method of claim 1, wherein:
the first plate is made of a silicon material, and the second plate is made of a glass material; and
the bonding of the first plate with the second plate is performed by anodic-bonding the first plate with the upper surface of the second plate.

5. The method of claim 1, wherein:
the second plate is made of a glass material, and the third plate is made of a silicon material; and
the bonding of the second plate with the third plate is performed by anodic-bonding the third plate with the lower surface of the second plate.
